(19) United States
(12) Patent Application Publication
(10) Pub. No.: US 2024/0296652 A1
(43) Pub. Date: Sep. 5, 2024

(54) CONTENT RECOGNITION METHOD AND APPARATUS, DEVICE, STORAGE MEDIUM, AND COMPUTER PROGRAM PRODUCT

(71) Applicant: Tencent Technology (Shenzhen) Company Limited, Shenzhen (CN)

(72) Inventors: Yunhao WANG, Shenzhen (CN); Tinghao YU, Shenzhen (CN); Shaohua CHEN, Shenzhen (CN); Hao LIU, Shenzhen (CN); Haodi HOU, Shenzhen (CN)

(21) Appl. No.: 18/662,871

(22) Filed: May 13, 2024

Related U.S. Application Data
(63) Continuation of application No. PCT/CN2023/099991, filed on Jun. 13, 2023.

(30) Foreign Application Priority Data
Aug. 4, 2022 (CN) 202210934770.8

(51) Int. Cl. G06V 10/46; G06V 10/25; G06V 10/42; G06V 10/80

(52) U.S. Cl. CPC G06V 10/462; G06V 10/25; G06V 10/42; G06V 10/806

(57) ABSTRACT

A content recognition method is performed by a computer device, which relate to the field of machine learning. The method includes: acquiring an image; recognizing a target region from the image by performing saliency detection on the image; extracting a key point feature representation corresponding to an image key point in the image; performing pooling on an image feature representation corresponding to the image to obtain a global feature representation; and recognizing a category of target content comprised in the target region based on the global feature representation and the key point feature representation.

### CROSS-REFERENCE TO RELATED APPLICATIONS

This application is a continuation application of PCT Patent Application No. PCT/CN2023/099991, entitled “CONTENT RECOGNITION METHOD AND APPARATUS, DEVICE, STORAGE MEDIUM, AND COMPUTER PROGRAM PRODUCT” filed on Jun. 13, 2023, which claims priority to Chinese Patent Application No. 202210934770.8, entitled “CONTENT RECOGNITION METHOD AND APPARATUS, DEVICE, STORAGE MEDIUM, AND COMPUTER PROGRAM PRODUCT” filed on Aug. 4, 2022, all of which is incorporated herein by reference in its entirety.

### FIELD OF THE TECHNOLOGY

This application relates to the field of machining learning, and in particular, to a content recognition method and apparatus, a device, a storage medium, and a computer program product.

### BACKGROUND OF THE DISCLOSURE

With the continuous development of Internet technologies, users browse a large amount of multimedia content every day, such as pictures, videos, and articles. Attribute information corresponding to multimedia content is determined by determining category information included in the multimedia content, so as to better meet browsing requirements of a user in different scenarios. For example, in an image search scenario, after the user enters a search keyword, an image whose image content matches the search keyword is selected from an image library as a search result and displayed to the user.

In the related art, generally, global features corresponding to images are extracted by using a deep learning model and a content search library is built. In the image search scenario, after the user enters the search keyword, a global feature matching the search keyword is determined in the content search library according to the search keyword, so that an image corresponding to the global feature is directly used as a search result and displayed to the user.

However, in the related art, generally, an image matching a search keyword is determined only according to a global feature of the image. Although the global feature corresponding to the image has a high degree of matching with the search keyword, there may still be a situation where the image does not match the search keyword, resulting in low accuracy of content recognition.

### SUMMARY

Embodiments of this application provide a content recognition method and apparatus, a device, a storage medium, and a computer program product, which can improve accuracy of content recognition. The technical solutions are as follows:

According to one aspect, a content recognition method is provided, the method including:
acquiring an image;
recognizing a target region from the image by performing saliency detection on the image;
extracting a key point feature representation corresponding to an image key point in the image;
performing pooling on an image feature representation corresponding to the image to obtain a global feature representation; and
recognizing a category of target content included in the target region based on the global feature representation and the key point feature representation.

According to another aspect, a computer device is provided, the computer device including a processor and a memory, the memory storing at least one instruction, at least one program, a code set, or an instruction set, and the at least one instruction, the at least one program, the code set, or the instruction set being loaded and executed by the processor and causing the computer device to implement the content recognition method according to any one of the embodiments of this application as described above.

According to another aspect, a non-transitory computer-readable storage medium is provided, the storage medium storing at least one instruction, at least one program, a code set, or an instruction set, and the at least one instruction, the at least one program, the code set, or the instruction set being loaded and executed by a processor of a computer device and causing the computer device to implement the content recognition method according to any one of the embodiments of this application as described above.

The technical solutions provided in the embodiments of this application have at least the following beneficial effects:

The image key point is extracted based on the distribution rule of pixel points in the image, the key point feature representation corresponding to the image key point is extracted, and the target region in the image is obtained by performing saliency detection on the image. Pooling is performed on the image feature representation corresponding to the image to obtain the global feature representation, the image feature representation is downsampled based on the target region, and feature concatenation is performed on the first local feature representation obtained after the downsampling and the key point feature representation to obtain the second local feature representation, so as to recognize the category of the target content included in the target region based on the global feature representation and the second local feature representation. That is, global-level pooling is performed on the image feature representation to obtain a global feature representation representing global information. Local-level downsampling processing is performed on the image feature representation based on the target region to obtain the first local feature representation representing local information, thereby effectively extracting effective information about local features in the image feature representation, then a purpose of combining the image key point to obtain a more accurate second local feature representation can be achieved when feature concatenation is performed on the first local feature representation and the key point feature representation, and the recognition of the category of the target content included in the target region by using the global feature representation and the second local feature representation can effectively improve accuracy of recognition of the category corresponding to the content.

### BRIEF DESCRIPTION OF THE DRAWINGS

FIG. 1 is a schematic diagram of the related art of a content recognition method according to an exemplary embodiment of this application.

FIG. 2 is a schematic diagram of an implementation environment according to an exemplary embodiment of this application.

FIG. 3 is a flowchart of a content recognition method according to an exemplary embodiment of this application.

FIG. 4 is a flowchart of a content recognition method according to another exemplary embodiment of this application.

FIG. 5 is a flowchart of a content recognition method according to another exemplary embodiment of this application.

FIG. 6 is a schematic diagram of a target region according to an exemplary embodiment of this application.

FIG. 7 is a schematic diagram of a target region according to another exemplary embodiment of this application.

FIG. 8 is a schematic diagram of a saliency detection model according to an exemplary embodiment of this application.

FIG. 9 is a schematic diagram of a content recognition method according to another exemplary embodiment of this application.

FIG. 10 is a structural block diagram of a content recognition apparatus according to an exemplary embodiment of this application.

FIG. 11 is a structural block diagram of a content recognition apparatus according to another exemplary embodiment of this application.

FIG. 12 is a schematic structural diagram of a server according to an exemplary embodiment of this application.

### DESCRIPTION OF EMBODIMENTS

To make the objectives, technical solutions, and advantages of this application clearer, the following further describes implementations of this application in detail with reference to the accompanying drawings.

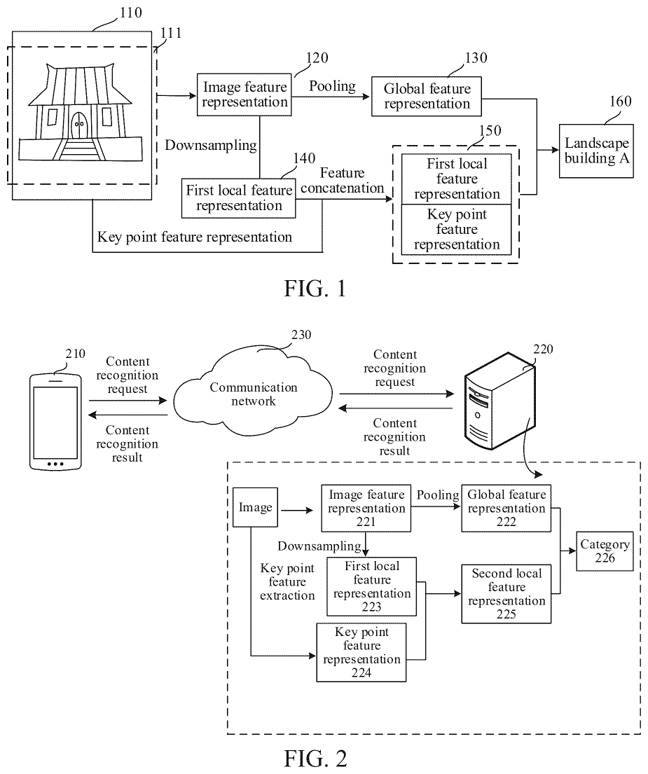

Schematically, FIG. 1 is a schematic diagram of a content recognition method according to an exemplary embodiment of this application. As shown in FIG. 1, an image 110 is acquired. The image 110 is implemented as an attraction image. An image key point (not shown in the figure) corresponding to the image 110 can be extracted through a distribution rule of pixel points in the image 110, thereby extracting a key point feature representation corresponding to the image key point. In addition, a target region in the image can be obtained by performing saliency detection on the image.

Pooling is performed on an image feature representation corresponding to the image to obtain a global feature representation 130 that refers to global information of the image, and the image feature representation 120 is downsampled based on the target region obtained based on saliency detection, to obtain a first local feature representation 140 that refers to local information of the target region in the image.

Feature concatenation is performed on the first local feature representation 140 and the key point feature representation to obtain a second local feature representation 150. A category of target content 111 in the target region in the image 110 is recognized according to the global feature representation 130 and the second local feature representation 150, to obtain a content recognition result 160. The content recognition result 160 is implemented as “Landscape building A”, which represents the category corresponding to the target content 111.

An implementation environment involved in the embodiments of this application is described. Schematically, referring to FIG. 2, the implementation environment involves a terminal 210 and a server 220. The terminal 210 and the server 220 are connected by a communication network 230.

Schematically, the terminal 210 transmits a content recognition request to the server. The content recognition request includes an image. The image includes target content. The server 220, after receiving the content recognition request transmitted from the terminal 210, recognizes content of the image, and feeds back a recognized content recognition result to the terminal 210. The content recognition result reflects a category corresponding to the target content.

During the recognition of the content of the image, the server 220 can obtain a target region in the image by performing saliency detection on the image. In addition, pooling is performed on an image feature representation corresponding to the image to obtain a global feature representation 222, and the image feature representation is downsampled based on the target region to obtain a first local feature representation 223. In addition, an image key point is extracted based on a distribution rule of pixel points in the image, then a key point feature representation 224 corresponding to the image key point and in the image is extracted, feature concatenation is performed on the key point feature representation 224 and the first local feature representation 223 to obtain a second local feature representation 225, and the target content is recognized according to the second local feature representation 225 and the global feature representation 222, to determine a category 226 corresponding to the target content.

The above terminal 210 may be a terminal device in various forms such as a mobile phone, a tablet computer, a desktop computer, a portable notebook computer, a smart TV, and a smart car, which is not limited in this embodiment of this application.

The above server 220 may be a stand-alone physical server, may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

A cloud technology is a hosting technology that unifies a series of resources such as hardware, software, and networks in a wide area network or a local area network to implement computing, storage, processing, and sharing of data.

In some embodiments, the above server 220 may alternatively be implemented as a node in a blockchain system.

The information (including, but not limited to, user equipment information, user personal information, and the like), data (including, but not limited to, data used for analysis, stored data, displayed data, and the like), and signals involved in this application are authorized by the user or fully authorized by all parties, and collection, use, and processing of relevant data need to comply with relevant laws, regulations, and standards of relevant countries and regions. For example, the image involved in this application is acquired in a case of sufficient authorization.

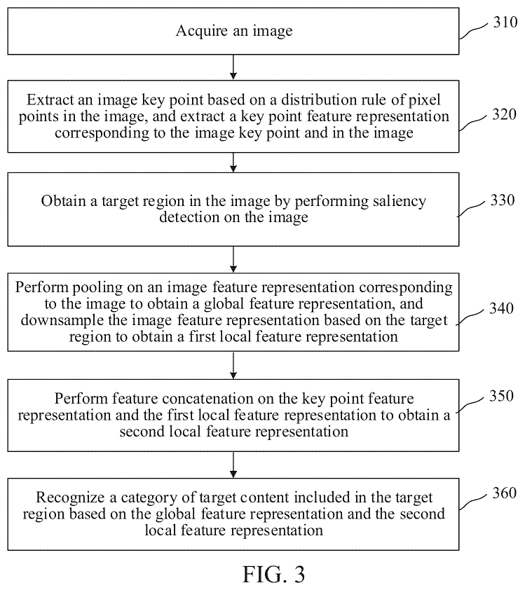

Schematically, the content recognition method provided in this application is described. Refer to FIG. 3 which is a flowchart of a content recognition method according to an exemplary embodiment of this application. The method may be performed by a terminal or a server, or by both a terminal and a server. In this embodiment, the method is performed by a server. As shown in FIG. 3, the method includes the following steps.

Step 310: Acquire an image.

Schematically, the image is an image acquired from an open-source image database. Alternatively, the image is an image collected by an image collection device (a device such as a camera, a terminal, or a video camera). Alternatively, the image is an image synthesized by image synthesis software. Alternatively, the image is a screenshot taken from a video.

Step 320: Extract an image key point based on a distribution rule of pixel points in the image, and extract a key point feature representation corresponding to the image key point and in the image.

The distribution rule of pixel points is used for representing changes between different pixel points. Schematically, a pixel is a unit that represents image resolution, the image may be regarded as content formed by a plurality of pixels, each pixel corresponds to a pixel point, and according to representation content of the image resolution, each pixel point corresponds to a pixel value. The distribution rule of pixel points represents changes in pixel values corresponding to different pixel points in the image.

In some embodiments, pixel values respectively corresponding to a plurality of pixel points in the image are comprehensively analyzed, the distribution rule of pixel points in the image is determined according to changes in the pixel values, and then the image key point corresponding to the image is extracted based on the distribution rule of pixel points. The image key point includes pixel points in the image that symbolize target content.

In some embodiments, a pixel point whose distribution rule of pixel points meets a preset condition is taken as the above image key point.

Schematically, the preset condition is implemented as pixel value change amplitude exceeding a preset amplitude threshold. For example, if pixel values corresponding to two adjacent pixel points change significantly (exceeding the preset amplitude threshold), at least one of the pixel points is taken as the above image key point. Alternatively, the preset condition is implemented as a pixel value change speed exceeding a preset speed threshold. For example, if pixel values corresponding to a plurality of adjacent pixel points change rapidly (exceeding the preset speed threshold), at least one of the pixel points is taken as the above image key point.

In some embodiments, a type of the image key point includes at least one of key point types such as a corner point, a boundary, and a block, which is not limited in this embodiment of this application.

In some embodiments, the image is correspondingly marked with a single image key point. Alternatively, the image is correspondingly marked with a plurality of image key points, which is not limited in this embodiment of this application.

Schematically, the image key point is content recognized based on the entire image, so information that needs to be highlighted in the entire image can be displayed to some extent. The image generally includes a target region and a background region. The target region represents a main expression region of the image, which includes a large amount of information highlighted in the image. The background region represents a minor expression region of the image, which includes a small amount of information highlighted in the image.

When a plurality of image key points are extracted based on the image, a large number of image key points in the plurality of image key points refer to information expressed by the target region, and a small number of image key points in the plurality of image key points refer to information expressed by the background region. Therefore, the plurality of image key points extracted mainly express the information corresponding to the target region, and may also reflect information outside the target region in the image to a small extent.

For example, the plurality of image key points extracted include an image key point 1 to an image key point 10. The image key point 1 to the image key point 8 are all key points extracted from the target region, and the image key point 9 to the image key point 10 are image key points extracted from outside the target region in the image.

In some embodiments, key points are extracted from the image through a preset key point detector, and a result outputted by the key point detector is taken as the image key point corresponding to the image.

In an exemplary embodiment, feature extraction is performed on the image key point extracted, to obtain the key point feature representation corresponding to the image key point and in the image.

In some embodiments, feature extraction is performed on all the image key points, to obtain key point feature representations corresponding to all the image key points, and the key point feature representations are used for subsequent feature concatenation; Or feature extraction is performed on part of the image key points, to obtain key point feature representations corresponding to the part of the image key points, which is not limited in this embodiment of this application.

Step 330: Obtain a target region in the image by performing saliency detection on the image.

Schematically, the saliency detection is used for using an image processing technology and a computer vision algorithm to position a most “salient” region in the image, which is the target region. In some embodiments, the saliency detection is used for determining a region including target content. The region is the target region. The target region refers to an eye-catching region or a relatively important region in the image, for example, a region that a human eye first focuses on when looking at a picture. In some embodiments, a process of automatically positioning key content in an image or an important region in a scenario is called saliency detection. The saliency detection is widely used in many image recognition fields such as target detection and robotics.

That is, the saliency detection is detection of important content in the image. Therefore, after the target region is obtained by the saliency detection, the target region represents content of a fixed region. Compared with the image key point extracted from the image, the target region that the saliency detection focuses on is more unitary, and the target region is more specific than the image key point which may exist in many regions in the image.

In some embodiments, the saliency detection is implemented as a threshold-based region segmentation method.

Schematically, pixel values of the pixel points in the image are acquired, when pixel values respectively corresponding to a plurality of consecutive pixel points reach a preset pixel threshold, a region formed by the plurality of consecutive pixel points is taken as the above target region, and a region outside the target region in the image is taken as the background region, so as to realize a segmentation process of the target region and the background region. The process is regarded as a process of performing saliency detection on the image to obtain the target region.

In some embodiments, the saliency detection is implemented as an boundary-detection-based region segmentation method.

Schematically, considering that grayscale values of pixel points on boundaries of different regions generally change drastically, the image may be transformed from a space domain to a frequency domain by Fourier transform, and the boundaries of the regions correspond to high-frequency portions. Therefore, the different regions can be segmented more intuitively, thereby better separating the target region from the background region in the image.

In some embodiments, the saliency detection is implemented as a method for image recognition through a pre-trained image segmentation model.

Schematically, a pre-trained image segmentation model for image segmentation is acquired, and the target region and the background region in the image are separated by inputting the image into the image segmentation model. In some embodiments, a pre-trained model of the trained image segmentation model is implemented as a model developed by a visual geometry group (VGG). A VGG model is trained through a large number of sample images to obtain an image segmentation model. The large number of sample images include region labels that refer to target regions in the sample images. A model training process is realized by means of differences between prediction results of the sample images by the VGG model and the region labels marked on the sample images, and finally the image is recognized by means of the trained image segmentation model to obtain the target region in the image, thereby achieving a purpose of saliency detection.

The above saliency detection method is merely an illustrative example, and the above purpose of saliency detection can be achieved with various methods that can separate the target region from the image, which is not limited in this embodiment of this application.

In some embodiments, the target region is used for representing a region including target content.

Schematically, the image is an image including target content of an unknown category. The target content includes at least one of content types such as people, animals, food, attractions, and landmarks.

In some embodiments, the saliency detection is used for determining the target region corresponding to the target content and the background region corresponding to background content in the image. That is, the saliency detection is used for dividing the image into regions based on content features to separate the target region from the background region.

Schematically, the target content represents content different from other background content in the image. Therefore, through the saliency detection, the target region corresponding to the target content can be separated from the background region corresponding to the background content, thereby determining the target region including the target content in the image.

For example, if pixel values corresponding to pixel points in the target region are larger, pixel values corresponding to pixel points in the background region is smaller. The process of saliency detection is realized by setting a pixel threshold, thereby separating the target region from the background region. Alternatively, the process of saliency detection is realized by image sharpening. That is, the image is sharpened to enhance boundary detail information in the image, thereby realizing a process of enhancing a boundary between the target region and the background region to separate the target region from the background region.

In some embodiments, the image includes a single piece of target content; or the image includes a plurality of pieces of target content. When the image includes a plurality of pieces of target content, the plurality of pieces of target content correspond to different content or correspond to same content, which is not limited herein.

Schematically, when the image includes a single piece of target content, the target region is implemented as a single region including the single piece of target content. Alternatively, when the image includes a plurality of pieces of target content, the target region is implemented as a single region including the plurality of pieces of target content. Alternatively, when the image includes a plurality of pieces of target content, the target region is implemented as a plurality of regions, and each target region includes at least one piece of target content, or the like.

In some embodiments, a saliency detection model is preset, the image is inputted into the saliency detection model, and a recognition saliency map corresponding to the image is outputted. The recognition saliency map includes the target region corresponding to the target content and the background region corresponding to the background content. The recognition saliency map is implemented as an image after the target region is enhanced.

Step 340: Perform pooling on an image feature representation corresponding to the image to obtain a global feature representation, and downsample the image feature representation based on the target region to obtain a first local feature representation.

Schematically, the pooling refers to downsampling the image feature representation to compress the image feature representation, which reduces a quantity of parameters while maintaining some invariance of the image feature representation (e.g., at least one of rotation invariance, translation invariance, and scaling invariance).

In some embodiments, the pooling is implemented through a convolution kernel. By means of an image size corresponding to the image and a convolution kernel size corresponding to the convolution kernel, the global feature representation of the image after pooling is obtained.

Schematically, the image size corresponding to the image is determined. The convolution kernel used for pooling the image is acquired, and the convolution kernel size of the convolution kernel is acquired. Pooling is performed on the image with the convolution kernel to obtain the global feature representation. The global feature representation is a quotient of the image size and the convolution kernel size.

For example, the image size of the image is 20*20, and the convolution kernel size of the convolution kernel used is 10*10. Pooling is performed on the image through the convolution kernel, and a size of the processed global feature representation obtained is 2*2. Alternatively, the image size of the image is 20*20, and the convolution kernel size of the convolution kernel used is 5*5. Pooling is performed on the image through the convolution kernel, and a size of the processed global feature representation obtained is 4*4.

The image size of the image and the convolution kernel size of the convolution kernel are merely illustrative examples, which are not limited in this embodiment of this application. The pooling process performed by means of the convolution kernel can greatly reduce complexity of analysis when feature representation analysis is performed, and can also use a smaller size to increase a receptive field of the entire image and improve an expression effect of the global feature representation on a global expression of the image.

In some embodiments, the pooling includes at least one of pooling types such as mean-pooling, max-pooling, and generalized-mean pooling (GeM), which is not limited. The three types of pooling will be described in detail in subsequent embodiments, which are not described in detail herein.

In an exemplary embodiment, after the image is divided into regions to obtain the target region, the image feature representation corresponding to the image is downsampled based on the target region.

Schematically, the downsampling, also known as feature downsampling, refers to image sampling and image reduction on the image feature representation, thereby obtaining a processed feature vector, which is the first local feature representation.

In some embodiments, the feature downsampling includes sparse sampling.

In some embodiments, the pooling and the downsampling are performed at the same time; or the pooling is performed on the image feature representation, and then the image feature representation is downsampled, which is not limited.

In some embodiments, the image is formed by a plurality of image patches, the image feature representation is formed by a plurality of sub-feature representations, and the plurality of image patches are in one-to-one correspondence to the plurality of sub-feature representations.

Schematically, the image is formed by the plurality of image patches, and the plurality of image patches include an image patch 1 to an image patch 9. The image patch 1 corresponds to a sub-feature representation a, the image patch 2 corresponds to a sub-feature representation b, . . . , and the image patch 9 corresponds to a sub-feature representation i.

In some embodiments, a plurality of regional image patches in the target region are acquired from the plurality of image patches included in the image.

The regional image patches are used for representing image patches located in the target region.

Schematically, each image patch corresponds to a sub-feature representation, and the plurality of image patches forming the image respectively correspond to a sub-feature representation. Therefore, a plurality of sub-feature representations are obtained, and the plurality of sub-feature representations corresponding to the image are called the image feature representation corresponding to the image.

For example, part of the image patches in the target region in the image include an image patch 3, an image patch 5, and an image patch 8, and the image patch 3, the image patch 5, and the image patch 8 are taken as regional image patches corresponding to the target region.

In some embodiments, from the plurality of sub-feature representations included in the image feature representation, sub-feature representations respectively corresponding to the plurality of regional image patches are acquired as the sparse sampling result.

Schematically, after the plurality of regional image patches in the target region are determined, the sub-feature representations respectively corresponding to the plurality of regional image patches and in the image feature representation are acquired, so as to obtain part of the sub-feature representations corresponding to the target region. The part of the sub-feature representations are taken as the sparse sampling result.

For example, after the regional image patches corresponding to the target region are determined to be the image patch 3, the image patch 5, and the image patch 8, a sub-feature representation c corresponding to the image patch 3, a sub-feature representation e corresponding to the image patch 5, and a sub-feature representation h corresponding to the image patch 8 are acquired from the plurality of sub-feature representations included in the image feature representation, and the sub-feature representation c, the sub-feature representation e, and the sub-feature representation h are taken as the above sparse sampling result.

In some embodiments, an expression form of the sparse sampling result may be implemented as a set of feature vectors; or the expression form of the sparse sampling result may be implemented as a feature vector map (feature matrix), that is, the feature vector map includes a plurality of feature patches, and each patch represents a feature vector (the sub-feature representation corresponding to the image patch), which is not limited in this embodiment of this application.

In some embodiments, a content recognition model is preset, and after the image is inputted into the content recognition model, the sparse sampling result corresponding to the target content is directly outputted; or the content recognition model is preset, after the image is inputted into the content recognition model, the image feature representation corresponding to the image is outputted, and the sparse sampling result corresponding to the target content is selected from the image feature representation based on the target region, which is not limited.

In some embodiments, the sparse sampling result is extracted in at least one of the following manners:

1. Feature extraction is performed by using a swin transformer model (a transformer based on a moving window), after the image is inputted into the swin transformer model, a feature map corresponding to the target content is outputted, and the feature map is taken as the sparse sampling result. Each patch in the feature map represents a sub-feature representation.

2. Feature extraction is performed by using a deep residual network (ResNet), and after the image is inputted into the ResNet, the sparse sampling result corresponding to the target content is acquired from a feature map outputted by each layer of the ResNet.

3. Feature extraction is performed by using a tokens-to-tokens vision transformer model (T2T-ViT model), and after the image is inputted into the T2T-ViT model, and a string sequence (a token sequence) corresponding to the target content is outputted as the sparse sampling result corresponding to the target content.

The above manners of extracting the sparse sampling result are merely illustrative examples, which is not limited in this embodiment of this application.

In some embodiments, pooling is performed on the sparse sampling result to obtain the first local feature representation.

Schematically, after the sparse sampling result is obtained, pooling may be performed on the sparse sampling result in the above manner of performing pooling by means of the convolution kernel, thereby obtaining the first local feature representation.

Schematically, if the sparse sampling result is implemented as the set of feature vectors above, the first local feature representation obtained after pooling is performed on the sparse sampling result is implemented as a result of a combination of a plurality of feature vectors. Alternatively, if the sparse sampling result is implemented as the feature vector map above, the first local feature representation obtained after pooling is performed on the sparse sampling result is implemented as a single feature vector, or the like.

The above are merely illustrative examples, which is not limited in this embodiment of this application.

Step 350: Perform feature concatenation on the key point feature representation and the first local feature representation to obtain a second local feature representation.

Schematically, the feature concatenation refers to concatenating feature vectors of the first local feature representation and the key point feature representation, and a feature vector obtained after the concatenation is taken as the second local feature representation.

In some embodiments, the feature concatenation is implemented through a neural network concatenate (concat) layer. A function of the concat layer is to concatenate two or more feature representations in a channel dimension.

Schematically, feature concatenation is performed on the key point feature representation and the first local feature representation along the channel dimension to obtain the second local feature representation.

During the feature concatenation, the key point feature representation and the first local feature representation are identical in feature size but are expanded in number of channels. Therefore, the second local feature representation obtained after the feature concatenation remains unchanged in feature size, and the numbers of channels are added.

For example, a size of the first local feature representation is: 1*H*W, and a size of the key point feature representation is C*H*W. 1 in the first local feature representation is used for denoting the number of channels of the first local feature representation, C in the key point feature representation is used for denoting the number of channels of the key point feature representation, and H is used for denoting a height of the first local feature or key point feature representation; and W is used for denoting a width of the first local feature or key point feature representation. When a classification feature representation and the image feature representation are channel-dimension concatenated along the channel dimension, the second local feature representation is obtained. A size of the second local feature representation is (C+1)*H*W.

In some embodiments, considering that a quantity of key point feature representations may not be unique and that a quantity of first local feature representations may not be unique, the feature concatenation manner is described based on the two factors.

Schematically, when there is a single key point feature representation and a single first local feature representation, the single key point feature representation and the single first local feature representation are concatenated according to the above feature concatenation method to obtain the second local feature representation.

Schematically, when there is a single key point feature representation and a plurality of first local feature representations, the above feature concatenation is performed on the plurality of first local feature representations to obtain a feature concatenation result, and the feature concatenation result is concatenated with the single key point feature representation to obtain the second local feature representation. Alternatively, after the single key point feature representation is concatenated with the plurality of first local feature representations respectively, feature concatenation results respectively corresponding to the plurality of first local feature representations are obtained, and feature concatenation is performed on the feature concatenation results to obtain the second local feature representation.

Schematically, when there are a plurality of key point feature representations and a single first local feature representation, the above feature concatenation is performed on the plurality of key point feature representations to obtain a feature concatenation result, and the feature concatenation result is concatenated with the single first local feature representation to obtain the second local feature representation. Alternatively, after the single first local feature representation is concatenated with the plurality of key point feature representations respectively, feature concatenation results respectively corresponding to the plurality of key point feature representations are obtained, and feature concatenation is performed on the feature concatenation results to obtain the second local feature representation.

Schematically, when there are a plurality of key point feature representations and a plurality of first local feature representations, the feature concatenation includes at least one of the following concatenation manners:

1. One first local feature representation and one key point feature representation are concatenated to obtain a single second local feature representation. That is, feature concatenation is performed on the first local feature representations and the key point feature representations one by one, and the second local feature representation includes a plurality of feature vectors obtained by feature concatenation.

2. Feature concatenation is performed first on the plurality of first local feature representations one by one, and concatenation results are then sequentially concatenated with the key point feature representations to obtain a final second local feature representation. That is, the second local feature representation includes a single feature vector obtained by concatenation.

3. Feature concatenation is performed on the plurality of first local feature representations one by one to obtain a first concatenation feature representation, feature concatenation is then performed on the plurality of key point feature representations to obtain a second concatenation feature representation, and then feature concatenation is performed on the first concatenation feature representation and the second concatenation feature representation to obtain the second local feature representation. That is, feature concatenation is performed first on the plurality of first local feature representations and the plurality of key point feature representations respectively, feature concatenation is then performed on feature vectors obtained by concatenation, and a concatenation result finally obtained is taken as the second local feature representation.

The above manners of feature concatenation are merely illustrative examples, which is not limited in this embodiment of this application.

Step 360: Recognize a category of target content included in the target region based on the global feature representation and the second local feature representation.

In some embodiments, a result obtained after recognition is called a content recognition result. That is, the content recognition result is used for representing the category corresponding to the target content.

Schematically, the content recognition result indicates a category name corresponding to the target content, for example, a content recognition result for target content a is “garden”; or the content recognition result indicates a category type corresponding to the target content, for example, a content recognition result for target content b is “Garden X”, which is not limited.

In some embodiments, the content recognition result includes a single piece of target content and a category corresponding thereto, for example, target content a, and a corresponding category “Park A”; and target content b, and a corresponding category “Park B”; or the content recognition result includes a plurality of categories, and each category corresponds to at least one piece of target content. For example, a category A is “dolphin”, and the category A includes target content 1 and target content 2 (that is, the target content 1 and the target content 2 are both “dolphin”); a category B is “clownfish”, and the category B includes target content 3 (that is, the target content 3 is “clownfish”), which is not limited.

In some embodiments, the category corresponding to the target content is implemented as a coarse-grained category. For example, the image includes target content A (a first playground) and target content B (a second playground). In a content recognition result finally obtained, categories corresponding to the target content A and the target content B are both “playground”. Alternatively, the category corresponding to the target content is implemented as a fine-grained category. For example, both target content A and target content B belong to “museum”, but it is finally recognized that the target content A is “Museum a” and the target content B is “Museum b”.

In conclusion, according to the content recognition method provided in this embodiment of this application, the image key point is extracted based on the distribution rule of pixel points in the image, the key point feature representation corresponding to the image key point is extracted, and the target region in the image is obtained by performing saliency detection on the image. In addition, pooling is performed on the image feature representation to obtain the global feature representation, the image feature representation is downsampled based on the target region, and feature concatenation is performed on the first local feature representation obtained after the downsampling and the key point feature representation to obtain the second local feature representation, so as to recognize the category of the target content included in the target region based on the global feature representation and the second local feature representation. That is, a process of downsampling the image feature representation based on the target region to obtain the first local feature representation can effectively extract effective information about local features in the image feature representation, then a purpose of combining the image key point to obtain a more accurate second local feature representation can be achieved when feature concatenation is performed on the first local feature representation and the key point feature representation, and content recognition on the image by using the global feature representation and the second local feature representation can effectively improve accuracy of the content recognition.

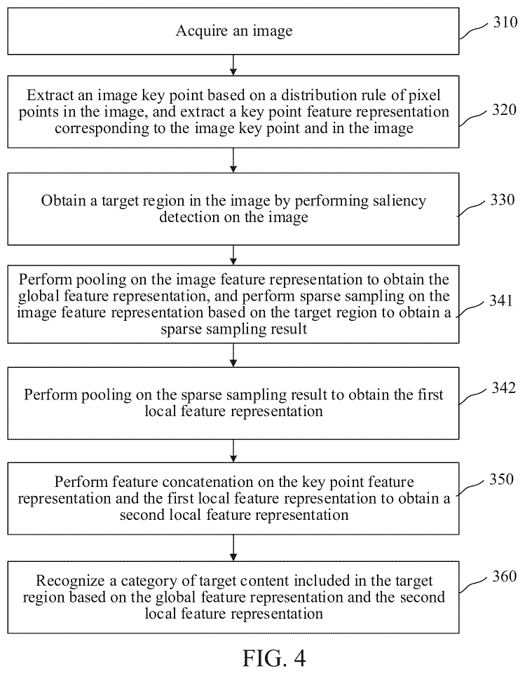

In an exemplary embodiment, both the first local feature representation and the global feature representation may be acquired through different types of pooling. Schematically, FIG. 4 is a schematic diagram of a content recognition method according to an exemplary embodiment of this application. As shown in FIG. 4, step 340 includes step 341 and step 342. The method includes the following steps:

Step 341: Perform pooling on the image feature representation to obtain the global feature representation, and perform sparse sampling on the image feature representation based on the target region to obtain a sparse sampling result.

Schematically, feature processing is performed on the image to obtain a plurality of image feature representations, and each image feature representation represents a feature representation of an image patch in the image.

In some embodiments, part of the image feature representations are selected from the plurality of image feature representations corresponding to the image for pooling, to obtain the global feature representation; or pooling is performed on all the image feature representations to obtain the global feature representation, which is not limited.

First, mean-pooling, max-pooling, and GeM are described in detail.

In some embodiments, the pooling includes any one of mean-pooling, max-pooling, and GeM.

Mean-pooling refers to averaging vectors of an inputted image feature representation, and taking a feature vector obtained by averaging as the global feature representation.

Max-pooling refers to selecting a feature vector with a maximum vector value from the inputted image feature representation as the global feature representation.

GeM refers to presetting a learnable parameter p, for the inputted image feature representation, first calculating a p^{th} power, averaging vectors, and calculating a p^{th} root, and taking a result obtained after the calculation of the p^{th} root as the global feature representation. Schematically, refer to Formula I for GeM:

$${f}_{d}^{( g )} = {( \frac{1}{\vert {X}_{k} \vert} {\sum }_{x ∈ {X}_{k}} {X}_{k}^{{p}_{k}} )}^{\frac{1}{{p}_{k}}} \qquad Formula I$$

As can be seen from Formula I, Xₖ denotes an image feature representation corresponding to a k^{th} image patch. When p=1, Formula I may be implemented as an averaging process. That is, Formula I is currently equivalent to mean-pooling. When p approaches infinity, Formula I may be implemented as taking a maximum value. That is, Formula I is currently equivalent to max-pooling.

Schematically, when p is larger, more attention is paid to local features.

Two manners of acquiring the global feature representation are described below.

In the first manner, the global feature representation is obtained by a single type of pooling.

In some embodiments, GeM is performed on the image feature representation to obtain the global feature representation. That is, GeM is performed on the image feature representation, and a pooling result obtained is taken as the global feature representation.

GeM is a method that combines generalized pooling and mean-pooling, which mainly calculates a weighted mean of regions covered by sliding of the convolution kernel on an inputted feature representation (i.e., the above image feature representation) to obtain each dimension of an outputted feature representation (i.e., the above global feature representation). A weighting coefficient involved in the weighted mean may be learned from a previous model, or may be a custom-set coefficient.

When GeM is performed on the image feature representation, a flexible processing process of the image feature representation can be realized. A generalization capability in the pooling process can be improved by means of the weighting coefficient during the GeM, which reduces computational costs of the pooling and improves processing efficiency of the pooling while reducing the feature size of the global feature representation.

In some embodiments, mean-pooling is performed on the image feature representation to obtain the global feature representation.

In some embodiments, max-pooling is performed on the image feature representation to obtain the global feature representation.

That is, any one of mean-pooling, max-pooling, and GeM is performed on the image feature representation to obtain the global feature representation. The global feature representation is used for representing a pooling result corresponding to a single type of pooling.

In the second manner, the global feature representation is obtained by different types of pooling.

In some embodiments, mean-pooling is performed on the image feature representation to obtain a first global feature representation; max-pooling is performed on the image feature representation to obtain a second global feature representation; GeM is performed on the image feature representation to obtain a third global feature representation; and feature concatenation is performed on the first global feature representation, the second global feature representation, and the third global feature representation to obtain the global feature representation.

In this embodiment, three different types of pooling are performed on the image feature representation respectively to obtain the first global feature representation, the second global feature representation, and the third global feature representation, on which feature concatenation is performed, and a feature concatenation result is taken as the global feature representation. That is, the global feature representation includes a concatenation result of pooling results corresponding to the three types of pooling.

In some embodiments, feature concatenation is performed on the first global feature representation, the second global feature representation, and the third global feature representation in a fixed order (for example, feature concatenation is performed in a concatenation order of the first global feature representation, the second global feature representation, and the third global feature representation); or feature concatenation is performed on the first global feature representation, the second global feature representation, and the third global feature representation in a random order, which is not limited.

Firstly, the sparse sampling is described in detail.

Schematically, the sparse sampling refers to performing sparse processing on the image feature representation to obtain a sparse vector matrix as the sparse sampling result. The image feature representation is a dense vector matrix, while the sparse sampling result is a sparse vector matrix. That is, the sparse sampling result includes a plurality of zero elements. In some embodiments, the zero elements represent image feature representations corresponding to unsampled image patches. Elements corresponding to the zero elements are one elements. The one elements are used for indicating image feature representations corresponding to sampled image patches.

In this embodiment, the image feature representation is implemented as a feature map (that is, a feature matrix) with a size of k×k×1024, n×1024 token vectors are obtained after sparse sampling is performed on the image feature representation, and the n×1024 token vectors are taken as the sparse sampling result. A number of the token vectors is a preset fixed quantity; or the number of the token vectors may be freely set according to an actual requirement, which is not limited.

In an exemplary embodiment, sparse sampling is performed on the image feature representation based on the target region to obtain the sparse sampling result.

Schematically, after the target region in the image is obtained, image feature representations corresponding to the image patches in the target region are implemented as one elements, and image feature representations corresponding to the image patches outside the target region are implemented as zero elements to implement a sparse sampling process of the image feature representation, so that the sparse sampling result can display, in a more targeted manner, local information corresponding to the target region.

Alternatively, after the target region in the image is obtained, values of image feature representations corresponding to a large number of the image patches in the target region are one elements, and values of image feature representations corresponding to a small number of the image patches outside the target region are zero elements to implement a sparse sampling process of the image feature representation, so that the sparse sampling result can display, in a more targeted manner, local information corresponding to the target region.

Alternatively, after the target region in the image is obtained, values of image feature representations corresponding to image patches in a region including the target region are one elements, and values of image feature representations corresponding to image patches outside the region are zero elements to implement a sparse sampling process of the image feature representation, so that the sparse sampling result can display, in a more targeted manner, local information corresponding to the target region.

In this embodiment, the processes of performing pooling and downsampling respectively on the image feature representation are performed simultaneously.

Step 342: Perform pooling on the sparse sampling result to obtain the first local feature representation.

In some embodiments, the pooling includes at least one of pooling manners such as mean-pooling, max-pooling, and GeM.

Schematically, two manners of acquiring the first local feature representation are described in detail.

In the first manner, a single type of pooling is performed on the sparse sampling result.

In an achievable situation, max-pooling is performed on the sparse sampling result, and the token vector with a maximum vector value in the sparse sampling result is selected as the first local feature representation.

In an achievable situation, mean-pooling is performed on the sparse sampling result, the sparse sampling result is averaged, and an obtained average vector is taken as the first local feature representation.

In an achievable situation, GeM is performed on the sparse sampling result, a learnable parameter p is set, pooling is performed on the sparse sampling result through Formula I above, and a pooling result obtained is taken as the first local feature representation.

For the above three different pooling manners, the first local feature representation includes feature vectors obtained by a single type of pooling.

In the second manner, different types of pooling are performed on the sparse sampling result.

In some embodiments, mean-pooling is performed on the sparse sampling result to obtain a third local feature representation; max-pooling is performed on the sparse sampling result to obtain a fourth local feature representation; GeM is performed on the sparse sampling result to obtain a fifth local feature representation; and feature concatenation is performed on the third local feature representation, the fourth local feature representation, and the fifth local feature representation to obtain the first local feature representation.

In this embodiment, mean-pooling, max-pooling, and GeM are performed on the sparse sampling result respectively to obtain the third local feature representation, the fourth local feature representation, and the fifth local feature representation respectively on which feature concatenation is performed, and a result obtained after the concatenation is taken as the first local feature representation. That is, the first local feature representation currently includes concatenation results corresponding to feature vectors obtained by different types of processing.

In some embodiments, three different types of pooling are performed simultaneously on the sparse sampling result; or pooling is performed on the sparse sampling result in a preset processing order of the three types of pooling, which is not limited. The preset processing order is a preset fixed order; or the preset processing order may be freely set according to an actual requirement.

In some embodiments, feature concatenation is performed on the third local feature representation, the fourth local feature representation, and the fifth local feature representation in a fixed order (for example, feature concatenation is performed in a concatenation order of the third local feature representation, the fourth local feature representation, and the fifth local feature representation); or feature concatenation is performed on the third local feature representation, the fourth local feature representation, and the fifth local feature representation in a random order, which is not limited.

The above two types of pooling for the image feature representation (including a single type of pooling and concatenation after a plurality of types of pooling) and two types of pooling for the sparse sampling result (including a single type of pooling and concatenation after a plurality of types of pooling) are merely illustrative examples. Any combination of the above types of pooling (i.e., including four combinations of pooling) may be selected respectively for the image feature representation and the sparse sampling result during application, for example, any two of the three types of pooling are adopted to perform processing and feature concatenation on the sparse sampling result to obtain the first local feature representation; or any two of the three types of pooling are adopted to perform processing and feature concatenation on the image feature representation to obtain the global feature representation, which is not limited in this embodiment of this application.

In conclusion, according to the content recognition method provided in this embodiment of this application, the image key point is extracted based on the distribution rule of pixel points in the image, the key point feature representation corresponding to the image key point is extracted, and the target region in the image is obtained by performing saliency detection on the image. In addition, pooling is performed on the image feature representation to obtain the global feature representation, the image feature representation is downsampled based on the target region, and feature concatenation is performed on the first local feature representation obtained and the key point feature representation to obtain the second local feature representation, so as to recognize the category of the target content in the target region according to the global feature representation and the second local feature representation to finally obtain a content recognition result. That is, a process of downsampling the image feature representation based on the target region to obtain the first local feature representation can effectively extract effective information about local features in the image feature representation, then a purpose of combining the image key point to obtain a more accurate second local feature representation can be achieved when feature concatenation is performed on the first local feature representation and the key point feature representation, and the recognition of a category of content of the image by using the global feature representation and the second local feature representation can effectively improve accuracy of content recognition.

In this embodiment, in the manner of performing sparse sampling on the image feature representation based on the target region, complexity of the image feature representation is reduced, a sparse sampling result with low complexity is obtained, then pooling is performed on the sparse sampling result to reduce a size of the target content while retaining image spatial information corresponding to the target region as much as possible, and the first local feature representation including high-dimensional local feature information is extracted, which improves efficiency of feature extraction and utilization of feature representations while effectively extracting corresponding local features in the image feature representation.

In this embodiment, an operational form of pooling is introduced. When pooling is performed on the sparse sampling result and the image feature representation, a corresponding feature representation may be obtained by using at least one of the above three processing manners. When a single type of pooling is selected, an operational form of the pooling can be simplified to some extent. When at least two types of pooling are selected, a more appropriate pooling manner may be determined according to processing conditions for the sparse sampling result and the image feature representation, improving flexibility of application of pooling.

For example, two different types of pooling are provided for the image feature representation, including a single pooling manner and a feature concatenation manner after different types of pooling. When any one of the pooling manners such as max-pooling, mean-pooling, and GeM is selected, a computational load of a pooling operation can be reduced to some extent, improving efficiency of acquisition of the global feature representation. When a manner of performing feature concatenation on features obtained after different types of pooling is selected, a purpose of more comprehensively analyzing the image feature representation is achieved by integrating the first global feature representation after mean-pooling, the second global feature representation after max-pooling, and the third global feature representation after GeM, which improves accuracy of acquisition of the global feature representation while improving diversity of selection of the pooling.

Alternatively, two different types of pooling are provided for the sparse sampling result, including a single pooling manner and a feature concatenation manner after different types of pooling. When any one of the pooling manners such as max-pooling, mean-pooling, and GeM is selected, a computational load of the pooling operation can be reduced to some extent, improving efficiency of acquisition of the first local feature representation. When a manner of performing feature concatenation on features obtained after different types of pooling is selected, a purpose of more comprehensively analyzing the sparse sampling result is achieved by integrating the third local feature representation after mean-pooling, the fourth local feature representation after max-pooling, and the fifth local feature representation after GeM, which improves accuracy of acquisition of the first local feature representation while improving diversity of selection of the pooling.

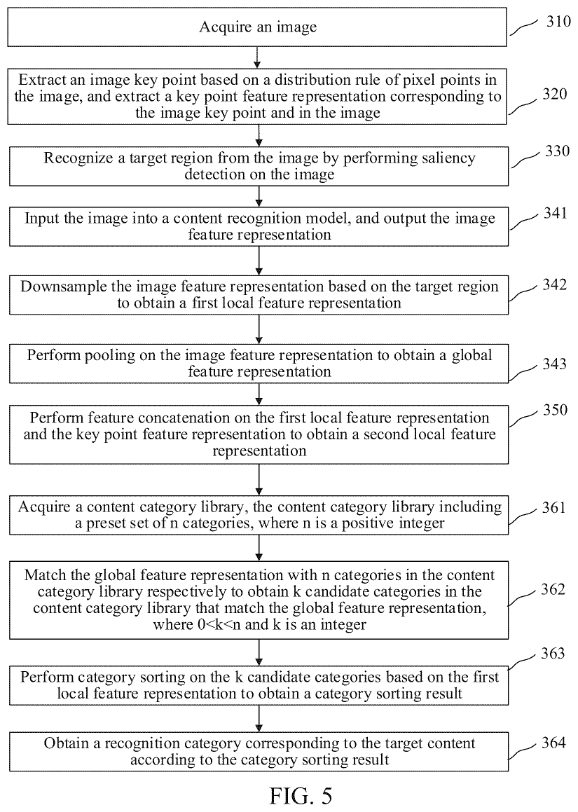

In an exemplary embodiment, the key point feature representation is acquired through a key point extraction algorithm, the image feature representation is acquired through a content recognition model, and a category recognition result of the target content in the target region is determined by a content category library. Schematically, FIG. 5 is a flowchart of a content recognition method according to an exemplary embodiment of this application. That is, step 340 may further include step 341 to step 343, and step 360 includes step 361 to step 364. As shown in FIG. 5, the method includes the following steps.

Step 310: Acquire an image.

Target content corresponds to an image key point in the image. The image key point is a key point extracted based on a distribution rule of pixel points in the image.

In some embodiments, a single image is acquired at a time; or a plurality of images are simultaneously acquired at a time, which is not limited in this embodiment of this application.

Schematically, the image is an image including target content of an unknown category, for example, an attraction image (including images of unknown attraction categories), a celebrity photo (including photo images of unknown celebrities), or an animation image (including images of unknown animation characters), which is not limited in this embodiment of this application.

In some embodiments, the image key point is a key point extracted by analyzing the pixel points in the image through a feature detector and according to the distribution rule of pixel points.

In some embodiments, the image key point is obtained in at least one of the following extraction manners:

1. The image key point corresponding to the image is extracted by scale invariant feature transform (SIFT) feature detection. During the SIFT feature detection, the image is inputted into a SIFT feature detector, and by use of difference of Gaussian (DOG) in the SIFT feature detector, an extreme point in the image is acquired as the image key point.

2. The image key point corresponding to the image is extracted by Speeded Up Robust Features (SURF, Speeded Up SIFT feature detection) feature detection. During the SURF feature detection, the image is inputted into a SURF feature detector, and the SURF feature detector performs key point detection on the image by using a determinant value of a Hessian matrix, to determine the image key point corresponding to the image.

3. The image key point corresponding to the target content in the image is extracted by Oriented FAST and Rotated BRIEF (ORB) feature detection, the image is inputted into an ORB feature detector, and the image key point corresponding to the image is determined.

The above manners of extracting the image key point are merely illustrative examples, which is not limited in this embodiment of this application.

Step 320: Extract an image key point based on a distribution rule of pixel points in the image, and extract a key point feature representation corresponding to the image key point and in the image.

In some embodiments, the key point feature representation corresponding to the image key point is extracted through a key point extraction algorithm.

In some embodiments, after the image key point is determined through a SIFT key point detector, a key point feature representation (a SIFT feature representation) corresponding to the image key point is extracted; or after the image key point is determined through a SURF key point detector, a key point feature representation (a SURF feature representation) corresponding to the image key point is extracted; or after the image key point is determined through an ORB key point detector, a key point feature representation (an ORB feature representation) corresponding to the image key point is extracted, which is not limited in this embodiment of this application.

In some embodiments, at least one of the SIFT feature representation, the SURF feature representation, and the ORB feature representation above is selected as the key point feature representation.

Step 330: Recognize a target region from the image by performing saliency detection on the image.

In some embodiments, the target region corresponding to the target content is recognized from the image by performing saliency detection on the image.

Schematically, the saliency detection is used for determining the target region corresponding to the target content and a background region corresponding to background content in the image. That is, the saliency detection is used for dividing the image into regions according to content features.

In some embodiments, a saliency detection model is preset, the image is inputted into the saliency detection model, and a recognition saliency map corresponding to the image is outputted. The recognition saliency map includes the target region corresponding to the target content and the background region corresponding to the background content. The recognition saliency map is implemented as an image after the target region is enhanced.

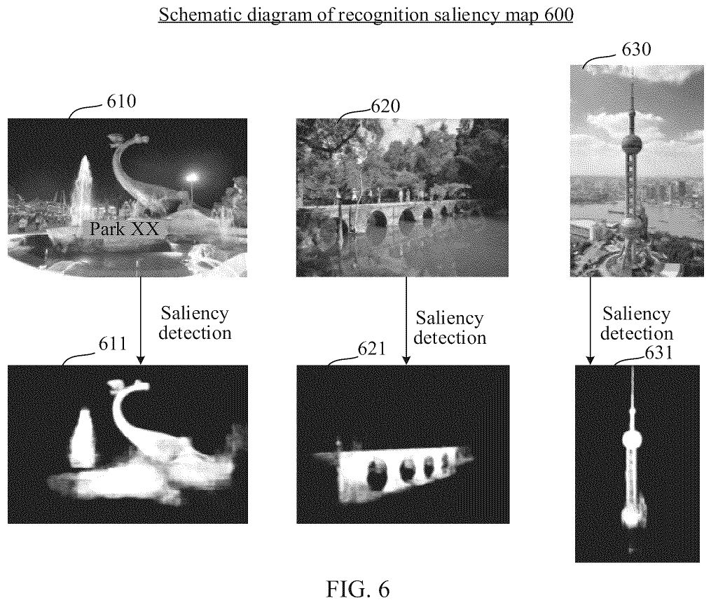

Schematically, FIG. 6 is a schematic diagram of a target region according to an exemplary embodiment of this application. As shown in FIG. 6, FIG. 6 shows a schematic diagram of a recognition saliency map 600 obtained after saliency detection on three different images, including a first image 610 and a first saliency map 611 corresponding to the first image 610, a second image 620 and a second saliency map 621 corresponding to the second image 620, and a third image 630 and a third saliency map 631 corresponding to the third image 630.

The first saliency map 611 includes a first target region (a white region), the second saliency map 621 includes a second target region (a white region), and the third saliency map 631 includes a third target region (a white region). In FIG. 6, the target regions are all marked and displayed as white regions, and background regions are marked and displayed as black regions.

In this embodiment, the recognition saliency map shown in FIG. 6 indicates that main features corresponding to current target content are more obvious. That is, the target regions in the current recognition saliency map are displayed with good completeness, and regional boundaries corresponding to the white regions are clearer.

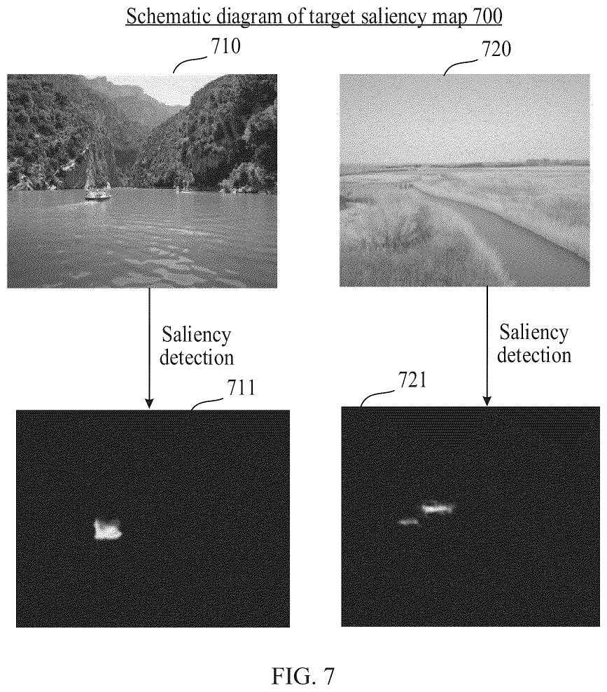

In addition, there is also a situation where the main features corresponding to the target content in the recognition saliency map are not obvious. Schematically, FIG. 7 is a schematic diagram of a target region according to an exemplary embodiment of this application. As shown in FIG. 7, FIG. 7 shows a schematic diagram 700 of a recognition saliency map obtained after saliency detection on two different images, including a fourth image 710 and a fourth saliency map 711 corresponding to the fourth image 710, and a fifth image 720 and a fifth saliency map 721 corresponding to the fifth image 720.

In the fourth saliency map 711 and the fifth saliency map 721, the white regions are target regions, and black regions are background regions. The fourth saliency map 711 and the fifth saliency map 721 currently belong to a situation where main features corresponding to target content are not obvious. That is, regional boundaries corresponding to the white regions are blurred.

In some embodiments, the saliency detection model includes at least one of a visual saliency transformer (VST) model and an edge guidance network for salient object detection (EGNet) model, which is not limited.

In this embodiment, the VST model is described in detail.

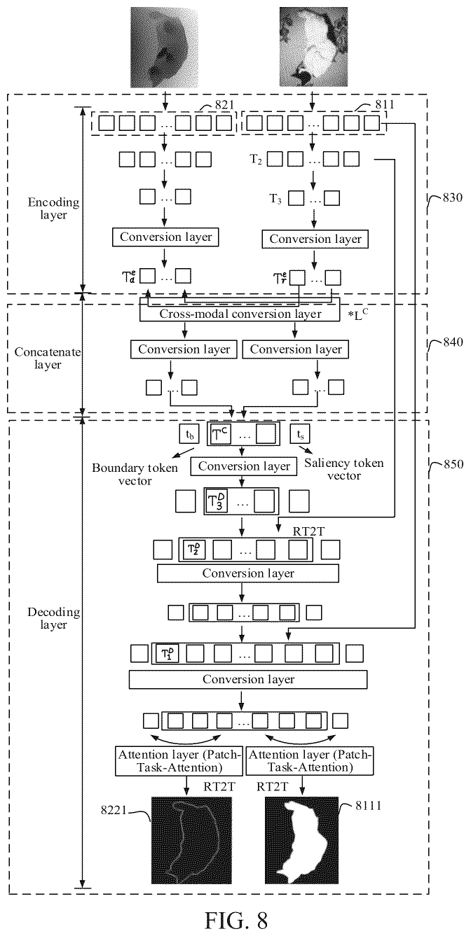

Schematically, FIG. 8 is a schematic diagram of a saliency detection model according to an embodiment of this application. As shown in FIG. 8, the VST model is currently displayed. The VST model includes a first image 810 and a second image 820. The first image 810 is an image (the image is an RGB image, whose color is not shown in FIG. 8). The second image 820 is a grayscale image (an RGB-D image) corresponding to the image. A first image patch 811 corresponding to the first image 810 and a second image patch 821 corresponding to the second image 820 are respectively inputted into a transformer encoder space 830. In the transformer encoder space 830, the first image patch 811 and the second image patch 821 are respectively encoded into multi-level token vectors (e.g., T1, T2, and T3) by using a token-to-token (T2T) module. The multi-level token vectors are inputted into a convertor 840. The convertor 840 is configured to convert the multi-level token vectors from the encoder space 830 to a transformer decoder space 850 for feature decoding, and a recognition saliency map 8111 corresponding to the first image 810 and a recognition boundary map 8221 corresponding to the second image 820 are outputted.

In the VST model, in addition to using the transformer model structure, multi-level token vector fusion is also used, and a new token vector upsampling method is proposed under the transformer structure to obtain high-resolution saliency detection results. A multi-task decoder based on token vectors is also developed, which simultaneously performs saliency detection and boundary detection by introducing task-related token vectors and a patch-task-attention mechanism.

Step 341: Input the image into a content recognition model, and output the image feature representation.

The content recognition model is configured to perform deep feature extraction on the image.

In some embodiments, only a single image is inputted into the content recognition model at a time, and an image feature representation corresponding to the single image is outputted; or a plurality of images are simultaneously inputted into the content recognition model at a time, and image feature representations respectively corresponding to the plurality of images are simultaneously outputted, which is not limited.

In some embodiments, the image feature representation is implemented as a multi-dimensional feature vector map. The feature vector map includes a plurality of patches, and each patch represents a feature vector.

In some embodiments, the content recognition model includes at least one of a swin transformer model, a ResNet model, and a T2T-ViT model, which is not limited.

In this embodiment, the swin transformer model is used as the content recognition model. The swin transformer model is briefly introduced below.

The swin transformer model introduces two concepts: a hierarchical feature mapping process and a window attention conversion process. The hierarchical feature mapping process means that mapping processes of feature representations in the swin transformer model are gradually merged after output by each layer of the model and feature downsampling is performed to establish feature mapping with a hierarchical structure. The feature mapping with the hierarchical structure enables the swin transformer model to be well applied to the field of fine-grained feature prediction (e.g., the field of semantic segmentation).

A convolution-free feature downsampling method used in the swin transformer model is called patch merging. “Patch” refers to a minimum unit in the feature vector map. For example, in a feature vector map with a feature size of 14×14, there are 14×14=196 patches. That is, there are 196 feature patches.

A module used in the swin transformer model is based on standard window multi-headed self-attention (W-MSA). The W-MSA only calculates corresponding attention within each window. This transformation results in existence of a patch not belonging to any window, that is, the patch is in an isolated state, and existence of a window with an incomplete patch. The swin transformer model uses a “cyclic shift” technology to move the isolated patch to the window with the incomplete patch. After this shift, a window may be formed by non-adjacent patches in an original feature vector map. Therefore, a mask is applied during calculation to limit self-attention to adjacent patches.

In this embodiment, the image is inputted into the swin transformer model, and at the end of the swin transformer model, a k×k×1024 feature vector map is outputted as an image feature representation.

Step 342: Downsample the image feature representation based on the target region to obtain a first local feature representation.

Schematically, sparse sampling is performed on the image feature representation based on the target region to obtain the sparse sampling result. Pooling is performed on the sparse sampling result to obtain the first local feature representation.

In this embodiment, sparse sampling is performed on the k×k×1024 feature vector map to obtain n×1024 token vectors, and then mean-pooling is performed on the n×1024 token vectors to obtain local features.

In some embodiments, any one of max-pooling, mean-pooling, and GeM is performed on the sparse sampling result, and a pooling result is taken as the first local feature representation; or max-pooling, mean-pooling, and GeM are respectively performed on the sparse sampling result, and feature concatenation is performed on three pooling results to obtain the first local feature representation, which is not limited. In this embodiment, for example, mean-pooling is performed on the image feature representation, and a pooling result is taken as the first local feature representation.

Step 343: Perform pooling on the image feature representation to obtain a global feature representation.

In some embodiments, any one of max-pooling, mean-pooling, and GeM is performed on the image feature representation, and a pooling result is taken as the global feature representation; or max-pooling, mean-pooling, and GeM are respectively performed on the image feature representation, and feature concatenation is performed on three pooling results to obtain the global feature representation, which is not limited. In this embodiment, for example, GeM is performed on the image feature representation, and a pooling result is taken as the global feature representation.

Step 350: Perform feature concatenation on the first local feature representation and the key point feature representation to obtain a second local feature representation.

Schematically, feature concatenation is sequentially performed on the first local feature representation and the key point feature representation, and a feature concatenation result is taken as the second local feature representation.

In step 341 to step 342 above, a process of extracting the key point feature representation through a key point extraction algorithm and obtaining the second local feature representation is introduced. By means of the key point extraction algorithm, a key point corresponding to the image is determined and a key point feature representation corresponding to the key point is determined, so that the key point feature representation refers to the image key point, which facilitates the model to conduct targeted analysis on the image key point, reduces complexity of model recognition, and shortens model recognition time. Then, the key point feature representation is fused with the first local feature representation corresponding to the target region in the image feature representation, which highlights information of the image key point, improves overall perceptibility of the target content, improves expression intensity of the local feature representation for the target content, and improves accuracy of the second local feature representation.

Step 361: Acquire a content category library, the content category library including a preset set of n categories, where n is a positive integer.

Schematically, the content category library includes n pre-stored categories. A candidate feature representation corresponding to at least one candidate image (i.e., an image feature representation corresponding to the candidate image) is stored under each category. That is, the candidate feature representation corresponds to the category. For example, a plurality of images including poodles are stored under a category “Poodle”, and each poodle image is marked with a feature representation corresponding to the poodle as a candidate feature representation.

In some embodiments, the content category library is pre-acquired.

Step 362: Match the global feature representation with n categories in the content category library respectively to obtain k candidate categories in the content category library that match the global feature representation, where 0<k<n and k is an integer.

In some embodiments, the global feature representation is matched with the n categories in the content category library respectively to obtain global matching scores respectively corresponding to the n categories, where the global matching scores are used for representing probabilities that the target content belongs to the categories; the global matching scores respectively corresponding to the n categories are sorted to obtain a matching degree sorting result; and top k categories in the matching degree sorting result are taken as the k candidate categories that match the global feature representation.

In some embodiments, the global matching scores are determined based on distances between the global feature representation and respective candidate feature representations under the n categories in a vector space. For example, when the distances between the global feature representation and the candidate feature representations are smaller in the vector space, the global matching scores are higher; and when the distances between the global feature representation and the candidate feature representations are larger in the vector space, the global matching scores are lower.

Schematically, the corresponding candidate feature representations under all categories are traversed in the content category library according to the global feature representation, each candidate feature representation is matched with the global feature representation, and according to a situation of matching between the candidate feature representation under one category and a current global feature representation, a global matching score corresponding to the category is determined. A higher global matching score of the category indicates a higher degree of matching between the candidate feature representation under the category and the global feature representation. That is, there is a higher probability that a category corresponding to the current target content is the category.

Arrangement is performed in order from high to low according to the global matching scores to obtain the matching degree sorting result, and the top k categories in the matching degree sorting result are taken as the k candidate categories that match the global feature representation.

Step 363: Perform category sorting on the k candidate categories based on the first local feature representation to obtain a category sorting result.

Schematically, top k candidate categories with the highest content matching scores for the target content are selected from the content category library through the global feature representation, and for the k candidate categories, the k candidate categories are sorted again according to local feature representations, to obtain the category sorting result.

The first local feature representation is matched with candidate feature representations under the k candidate categories respectively, and local matching scores respectively corresponding to the k candidate categories are determined according to a situation of matching between the candidate feature representations and the first local feature representation. Each of the local matching scores is used for indicating a current situation of matching between the first local feature representation and the candidate feature representation under the category. A higher degree of matching indicates a higher local matching score corresponding to the category. The local matching scores respectively corresponding to the k candidate categories are sorted from high to low to obtain the category sorting result.

Step 364: Obtain a recognition category corresponding to the target content according to the category sorting result.

Schematically, a candidate category with the highest local matching score (or several higher ones) in the category sorting result is selected as the recognition category, which is taken as the content recognition result.

In conclusion, according to the content recognition method provided in this embodiment of this application, the image key point is extracted based on the distribution rule of pixel points in the image, the key point feature representation corresponding to the image key point is extracted, and the target region in the image is obtained by performing saliency detection on the image. Pooling is performed on the image feature representation corresponding to the image to obtain the global feature representation, the image feature representation is downsampled based on the target region, and feature concatenation is performed on the first local feature representation obtained after the downsampling and the key point feature representation to obtain the second local feature representation, so as to recognize the category corresponding to the target content in the target region based on the global feature representation and the second local feature representation. That is, a process of downsampling the image feature representation to obtain the first local feature representation can effectively extract effective information about local features in the image feature representation, then a purpose of combining the image key point to obtain a more accurate second local feature representation can be achieved when feature concatenation is performed on the first local feature representation and the key point feature representation, and the recognition of the category of the target content in the image by using the global feature representation and the second local feature representation can effectively improve accuracy of recognition of the category of the content.

In this embodiment, the target region of the target content in the image is determined by saliency detection, thereby effectively separating the target region and the background region in the image to enhance differentiation intensity of the target region. Then, when regional analysis is performed on the image feature representation through the target region, interference of the background region in the image can be effectively eliminated, expression intensity of the obtained image feature representation for the target region is improved, background content not including main features is filtered to the greatest extent, and accuracy and efficiency of recognition of a content category of the target content are improved.

In this embodiment, as shown in step 361 to step 364, in a process of obtaining the category corresponding to the target content based on the global feature representation and the second local feature representation, k matching candidate categories are selected from the content category library including n categories through the global feature representation representing global information content, the k candidate categories are then resorted according to local feature representations representing targeted local information content, and the category corresponding to the target content is determined according to the category sorting result. This effectively realizes a process of recognizing the target content from global to local, and improves standardization of the content recognition process by means of hierarchical analysis, and improves flexibility of content recognition while improving accuracy of content category recognition. In addition, by means of the global matching scores that match the global feature representation with the n categories in the content category library, a selection process of candidate categories is more intuitively implemented, which is conducive to acquiring the k candidate categories more comprehensively and accurately, thereby being conducive to improving the accuracy of content recognition.

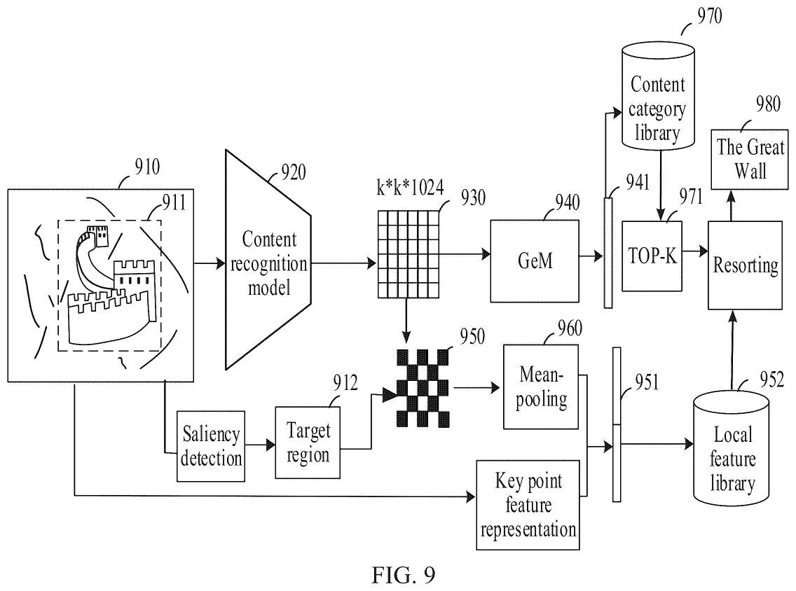

In an exemplary embodiment, an application scenario corresponding to the content recognition method provided in this application is described. Schematically, FIG. 9 is a schematic diagram of a content recognition method according to an exemplary embodiment of this application. The description is based on an example in which the content recognition method is applied to an image search scenario.

The user currently inputs an image as the image, and retrieves the image in an image library to obtain a recognized image with the highest degree of matching with the image as an image search result.

As shown in FIG. 9, an image 910 is acquired. The image 910 is the image inputted by the user. The image 910 includes target content 911. The image corresponds to a plurality of image key points (not shown in FIG. 9). The image key points are feature points detected by at least one of three key point detectors: a SIFT key point detector, an ORB key point detector, and a SURF key point detector.

The image 910 is inputted to a content recognition model 920, and an image feature representation 930 is outputted. The content recognition model 920 is implemented as a swin transformer model. The image feature representation 930 is implemented as a feature vector map with a feature size of k×k×1024 outputted by a final layer of the swin transformer model.

Saliency detection is performed on the image 910 to extract a target region 912. The target region 912 corresponds to the target content 911.

The saliency detection is implemented using a VST model.

GeM 940 and sparse sampling 950 are respectively performed on the image feature representation 930, to obtain a global feature representation 941 and a sparse sampling result 950 respectively.

In some embodiments, when the sparse sampling 950 is performed on the image feature representation 930 to obtain the sparse sampling result 950, the sparse sampling 950 is performed on the image feature representation 930 based on the target region 912.

Schematically, a feature representation corresponding to the target region 912 is extracted from the image feature representation 930 as the sparse sampling result 950 after sparse sampling. Alternatively, a feature representation corresponding to a region slightly larger than the target region 912 is extracted from the image feature representation 930 as the sparse sampling result after sparse sampling.

Mean-pooling 960 is performed on the sparse sampling result 950 to obtain a first local feature representation (not shown in FIG. 9), and the first local feature representation is concatenated with a key point feature representation (at least one of SIFT feature representations, SURF feature representations, and ORB feature representations) extracted by the image key point, to obtain a second local feature representation 951.

In addition, a feature dimension reduction operation is performed for a result obtained from the above pooling, to remove redundant features with high correlation between the feature representations.

Matching is performed in a category library 970 according to the global feature representation 941 to obtain top k candidate categories (TOP-K) with the highest global matching scores for the global feature representation 941 as k candidate categories 971.

The k candidate categories 971 are matched again according to a local feature library 952 that stores the first local feature representation 951, to obtain local matching degree scores corresponding to the k candidate categories 971, the k candidate categories are resorted according to the local matching scores, and the one with the highest local matching score is finally selected as a category 980 corresponding to the target content for output. The category 980 corresponding to the target content is implemented as “The Great Wall”.

The category corresponding to the target content is inputted to the image library, a candidate image corresponding to the category corresponding to the target content and in the image library is selected for output, and is displayed to the user.

In addition, the content recognition method provided in the embodiments of this application is also applicable to the following scenarios.

1. To be applied to account recommendations. For example, the user searches for a video account. A video posted by a current video account is marked with a candidate location. When the user inputs location content as search content, the video account is determined through the above content recognition method, and the video marked with a corresponding location and in the video account is weighted, thereby increasing a probability of recommending the video to the user.

2. To be applied to content recommendations. During recommendation of content to the user, if an image or video content in a recommendation library is recognized through the above content recognition method, the image or video content is recommended to the user.

In conclusion, according to the content recognition method provided in this embodiment of this application, the image key point is extracted based on the distribution rule of pixel points in the image, the key point feature representation corresponding to the image key point is extracted, and the target region in the image is obtained by performing saliency detection on the image. Pooling is performed on the image feature representation corresponding to the image to obtain the global feature representation, the image feature representation is downsampled, and feature concatenation is performed on the first local feature representation obtained after the downsampling and the key point feature representation to obtain the second local feature representation, so as to recognize the category of the target content in the image according to the global feature representation and the second local feature representation. That is, a process of downsampling the image feature representation based on the target region to obtain the first local feature representation can effectively extract effective information about local features in the image feature representation, then a purpose of combining the image key point to obtain a more accurate second local feature representation can be achieved when feature concatenation is performed on the second local feature representation and the key point feature representation, and the recognition of the category of the target content in the image by using the global feature representation and the second local feature representation can effectively improve accuracy of content recognition.

The content recognition method provided in this application has the following beneficial effects:

1) A structure is constructed in which the global feature representation performs content recall and the second local feature representation performs resorting.

2) Feature concatenation is performed on the first local feature representation and the key point feature representation to obtain the second local feature representation.

3) Saliency detection is introduced to prevent interference from background information.

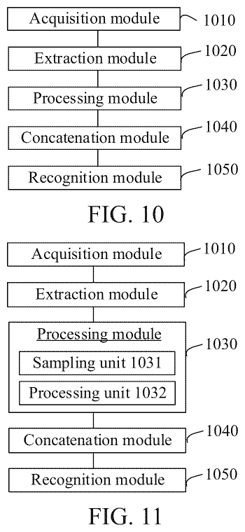

FIG. 10 is a structural block diagram of a content recognition apparatus according to an exemplary embodiment of this application. As shown in FIG. 10, the apparatus includes the following parts:
an acquisition module 1010 configured to acquire an image;
an extraction module 1020 configured to extract an image key point based on a distribution rule of pixel points in the image, and extract a key point feature representation corresponding to the image key point and in the image; and recognize a target region from the image by performing saliency detection on the image;
a processing module 1030 configured to perform pooling on an image feature representation corresponding to the image to obtain a global feature representation, and downsample the image feature representation based on the target region to obtain a first local feature representation;
a concatenation module 1040 configured to perform feature concatenation on the key point feature representation and the first local feature representation to obtain a second local feature representation; and
a recognition module 1050 configured to recognize a category of target content included in the target region based on the global feature representation and the second local feature representation.

In an exemplary embodiment, as shown in FIG. 11, the processing module 1030 includes:
a sampling unit 1031 configured to perform sparse sampling on the image feature representation based on the target region to obtain a sparse sampling result; and
a processing unit 1032 configured to perform pooling on the sparse sampling result to obtain the first local feature representation.

In an exemplary embodiment, the image is formed by a plurality of image patches, the image feature representation is formed by a plurality of sub-feature representations, and the plurality of image patches are in one-to-one correspondence to the plurality of sub-feature representations.

The processing module 1030 acquires a plurality of regional image patches in the target region from the plurality of image patches included in the image; and acquires, from the plurality of sub-feature representations included in the image feature representation, sub-feature representations respectively corresponding to the plurality of regional image patches as the sparse sampling result.

In an exemplary embodiment, the pooling includes any one of mean-pooling, max-pooling, and GeM.

In an exemplary embodiment, the processing unit 1032 is further configured to perform mean-pooling on the sparse sampling result to obtain a third local feature representation; perform max-pooling on the sparse sampling result to obtain a fourth local feature representation; perform GeM on the sparse sampling result to obtain a fifth local feature representation; and perform feature concatenation on the third local feature representation, the fourth local feature representation, and the fifth local feature representation to obtain the first local feature representation.

In an exemplary embodiment, the extraction module 1020 is further configured to extract the key point feature representation corresponding to the image key point through a key point extraction algorithm.

In an exemplary embodiment, the processing module 1030 is further configured to input the image into a content recognition model, and output the image feature representation, where the content recognition model is configured to perform deep feature extraction on the image; and perform GeM on the image feature representation to obtain the global feature representation.

In an exemplary embodiment, the processing module 1030 is further configured to perform mean-pooling on the image feature representation to obtain a first global feature representation; perform max-pooling on the image feature representation to obtain a second global feature representation; perform GeM on the image feature representation to obtain a third global feature representation; and perform feature concatenation on the first global feature representation, the second global feature representation, and the third global feature representation to obtain the global feature representation.

In an exemplary embodiment, the recognition module 1050 is further configured to acquire a content category library, the content category library including a preset set of n categories, where n is a positive integer; match the global feature representation with n categories in the content category library respectively to obtain k candidate categories in the content category library that match the global feature representation, where 0<k<n and k is an integer; perform category sorting on the k candidate categories based on the second local feature representation to obtain a category sorting result; and obtain a recognition category corresponding to the target content according to the category sorting result.

In an exemplary embodiment, the recognition module 1050 is further configured to match the global feature representation with the n categories in the content category library respectively to obtain global matching scores respectively corresponding to the n categories, the global matching scores being used for representing probabilities that the target content belongs to the categories; sort the global matching scores respectively corresponding to the n categories to obtain a matching degree sorting result; and take top k categories in the matching degree sorting result as the k candidate categories that match the global feature representation.

In conclusion, according to the content recognition apparatus provided in this embodiment of this application, the image key point is extracted based on the distribution rule of pixel points in the image, the key point feature representation corresponding to the image key point is extracted, and the target region in the image is obtained by performing saliency detection on the image. Pooling is performed on the image feature representation corresponding to the image to obtain the global feature representation, the image feature representation is downsampled based on the target region, and feature concatenation is performed on the first local feature representation obtained after the downsampling and the key point feature representation to obtain the second local feature representation, so as to recognize the category of the target content in the image according to the global feature representation and the second local feature representation. That is, a process of downsampling the image feature representation based on the target region to obtain the first local feature representation can effectively extract effective information about local features in the image feature representation, then a purpose of combining the image key point to obtain a more accurate second local feature representation can be achieved when feature concatenation is performed on the first local feature representation and the key point feature representation, and the recognition of the category of the target content in the image by using the global feature representation and the second local feature representation can effectively improve accuracy of content recognition.

The content recognition apparatus provided in the foregoing embodiments is illustrated with an example of division of the foregoing function modules. In practical application, the foregoing functions may be allocated to and completed by different function modules according to requirements, that is, an internal structure of a device is divided into different function modules, so as to complete all or part of the functions described above. In addition, the content recognition apparatus provided in the foregoing embodiments and the embodiments of the content recognition method belong to a same concept. For details of a specific implementation process thereof, refer to the method embodiments. Details are not described herein again.

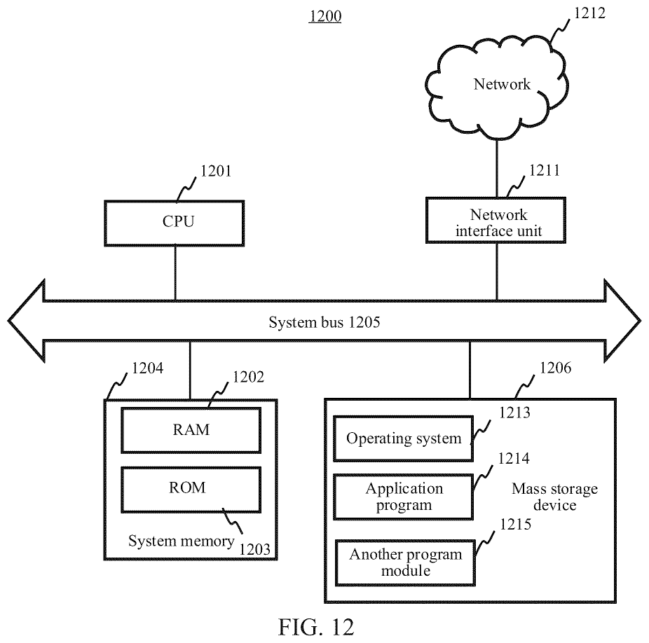

FIG. 12 is a schematic structural diagram of a server according to an exemplary embodiment of this application. Specifically,
the server 1200 includes a central processing unit (CPU) 1201, a system memory 1204 including a random access memory (RAM) 1202 and a read only memory (ROM) 1203, and a system bus 1205 connecting the system memory 1204 and the CPU 1201. The server 1200 further includes a mass storage device 1206 configured to store an operation system 1213, an application program 1214, and another program module 1215.

The mass storage device 1206 is connected to the CPU 1201 by using a mass storage controller (not shown) connected to the system bus 1205. The mass storage device 1206 and a computer-readable medium associated therewith provide non-volatile storage for the server 1200.

Generally, the computer-readable medium may include a computer storage medium and a communication medium.

According to various embodiments of this application, the server 1200 may be connected to a network 1212 by using a network interface unit 1211 connected to the system bus 1205, or may be connected to a network of another type or a remote computer system (not shown) by using the network interface unit 1211.

The memory further includes one or more programs, which are stored in the memory and are configured to be executed by the CPU.

An embodiment of this application further provides a computer device. The computer device includes a processor and a memory. The memory stores at least one instruction, at least one program, a code set, or an instruction set. The at least one instruction, the at least one program, the code set, or the instruction set is loaded and executed by the processor to implement the content recognition method provided in the foregoing method embodiments.

An embodiment of this application further provides a non-transitory computer-readable storage medium. The computer-readable storage medium stores at least one instruction, at least one program, a code set, or an instruction set. The at least one instruction, the at least one program, the code set, or the instruction set is loaded and executed by a processor to implement the content recognition method provided in the foregoing method embodiments.

An embodiment of this application further provides a computer program product or a computer program. The computer program product or the computer program includes a computer instruction. The computer instruction is stored in a non-transitory computer-readable storage medium. A processor of the computer device reads the computer instruction from the computer-readable storage medium. The processor executes the computer instruction, causing the computer device to perform the content recognition method according to any one of the above embodiments.

In some embodiments, the computer-readable storage medium may include: a ROM, a RAM, a solid state drive (SSD), an optical disc, or the like. The RAM may include a resistance random access memory (ReRAM) and a dynamic random access memory (DRAM). The sequence numbers of the foregoing embodiments of this application are merely for description purposes but do not imply the preference among the embodiments.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A content recognition method, performed by a computer device, the method comprising:
acquiring an image;
recognizing a target region from the image by performing saliency detection on the image;
extracting a key point feature representation corresponding to an image key point in the image;
performing pooling on an image feature representation corresponding to the image to obtain a global feature representation; and
recognizing a category of target content comprised in the target region based on the global feature representation and the key point feature representation.

2. The method according to claim 1, wherein the image key point is extracted from the image based on a distribution rule of pixel points in the image.

3. The method according to claim 1, wherein the method further comprises:
downsampling the image feature representation based on the target region to obtain a first local feature representation; and
performing feature concatenation on the key point feature representation and the first local feature representation to obtain a second local feature representation.

4. The method according to claim 3, wherein the downsampling the image feature representation based on the target region to obtain a first local feature representation comprises:
performing sparse sampling on the image feature representation based on the target region to obtain a sparse sampling result; and
performing pooling on the sparse sampling result to obtain the first local feature representation.

5. The method according to claim 3, wherein the recognizing a category of target content comprised in the target region based on the global feature representation and the key point feature representation comprises:
acquiring a content category library, the content category library comprising a preset set of n categories, where n is a positive integer;
matching the global feature representation with n categories in the content category library respectively to obtain k candidate categories in the content category library that match the global feature representation, where 0<k<n and k is an integer;
performing category sorting on the k candidate categories based on the second local feature representation to obtain a category sorting result; and
obtaining a recognition category corresponding to the target content according to the category sorting result.

6. The method according to claim 1, wherein the performing pooling on an image feature representation corresponding to the image to obtain a global feature representation comprises:
inputting the image into a content recognition model, and outputting the image feature representation, wherein the content recognition model is configured to perform deep feature extraction on the image; and
performing GeM on the image feature representation to obtain the global feature representation.

7. The method according to claim 1, wherein the performing pooling on an image feature representation corresponding to the image to obtain a global feature representation comprises:
performing mean-pooling on the image feature representation to obtain a first global feature representation;
performing max-pooling on the image feature representation to obtain a second global feature representation;
performing GeM on the image feature representation to obtain a third global feature representation; and
performing feature concatenation on the first global feature representation, the second global feature representation, and the third global feature representation to obtain the global feature representation.

8. A computer device comprising a processor and a memory, the memory storing at least one program, the at least one program being loaded and executed by the processor and causing the computer device to implement a content recognition method including:
acquiring an image;
recognizing a target region from the image by performing saliency detection on the image;
extracting a key point feature representation corresponding to an image key point in the image;
performing pooling on an image feature representation corresponding to the image to obtain a global feature representation; and
recognizing a category of target content comprised in the target region based on the global feature representation and the key point feature representation.

9. The computer device according to claim 8, wherein the image key point is extracted from the image based on a distribution rule of pixel points in the image.

10. The computer device according to claim 8, wherein the method further comprises:
downsampling the image feature representation based on the target region to obtain a first local feature representation; and
performing feature concatenation on the key point feature representation and the first local feature representation to obtain a second local feature representation.

11. The computer device according to claim 10, wherein the downsampling the image feature representation based on the target region to obtain a first local feature representation comprises:
performing sparse sampling on the image feature representation based on the target region to obtain a sparse sampling result; and
performing pooling on the sparse sampling result to obtain the first local feature representation.

12. The computer device according to claim 10, wherein the recognizing a category of target content comprised in the target region based on the global feature representation and the key point feature representation comprises:
acquiring a content category library, the content category library comprising a preset set of n categories, where n is a positive integer;
matching the global feature representation with n categories in the content category library respectively to obtain k candidate categories in the content category library that match the global feature representation, where 0<k<n and k is an integer;
performing category sorting on the k candidate categories based on the second local feature representation to obtain a category sorting result; and
obtaining a recognition category corresponding to the target content according to the category sorting result.

13. The computer device according to claim 8, wherein the performing pooling on an image feature representation corresponding to the image to obtain a global feature representation comprises:
inputting the image into a content recognition model, and outputting the image feature representation, wherein the content recognition model is configured to perform deep feature extraction on the image; and
performing GeM on the image feature representation to obtain the global feature representation.

14. The computer device according to claim 8, wherein the performing pooling on an image feature representation corresponding to the image to obtain a global feature representation comprises:
performing mean-pooling on the image feature representation to obtain a first global feature representation;
performing max-pooling on the image feature representation to obtain a second global feature representation;
performing GeM on the image feature representation to obtain a third global feature representation; and
performing feature concatenation on the first global feature representation, the second global feature representation, and the third global feature representation to obtain the global feature representation.

15. A non-transitory computer-readable storage medium storing at least one program, the at least one program being loaded and executed by a processor of a computer device and causing the computer device to implement a content recognition method including:
acquiring an image;
recognizing a target region from the image by performing saliency detection on the image;
extracting a key point feature representation corresponding to an image key point in the image;
performing pooling on an image feature representation corresponding to the image to obtain a global feature representation; and
recognizing a category of target content comprised in the target region based on the global feature representation and the key point feature representation.

16. The non-transitory computer-readable storage medium according to claim 15, wherein the image key point is extracted from the image based on a distribution rule of pixel points in the image.

17. The non-transitory computer-readable storage medium according to claim 15, wherein the method further comprises:
downsampling the image feature representation based on the target region to obtain a first local feature representation; and
performing feature concatenation on the key point feature representation and the first local feature representation to obtain a second local feature representation.

18. The non-transitory computer-readable storage medium according to claim 17, wherein the recognizing a category of target content comprised in the target region based on the global feature representation and the key point feature representation comprises:
acquiring a content category library, the content category library comprising a preset set of n categories, where n is a positive integer;
matching the global feature representation with n categories in the content category library respectively to obtain k candidate categories in the content category library that match the global feature representation, where 0<k<n and k is an integer;
performing category sorting on the k candidate categories based on the second local feature representation to obtain a category sorting result; and
obtaining a recognition category corresponding to the target content according to the category sorting result.

19. The non-transitory computer-readable storage medium according to claim 15, wherein the performing pooling on an image feature representation corresponding to the image to obtain a global feature representation comprises:
inputting the image into a content recognition model, and outputting the image feature representation, wherein the content recognition model is configured to perform deep feature extraction on the image; and
performing GeM on the image feature representation to obtain the global feature representation.

20. The non-transitory computer-readable storage medium according to claim 15, wherein the performing pooling on an image feature representation corresponding to the image to obtain a global feature representation comprises:
performing mean-pooling on the image feature representation to obtain a first global feature representation;
performing max-pooling on the image feature representation to obtain a second global feature representation;
performing GeM on the image feature representation to obtain a third global feature representation; and
performing feature concatenation on the first global feature representation, the second global feature representation, and the third global feature representation to obtain the global feature representation.
